(19) United States
(12) Patent Application Publication
(10) Pub. No.: US 2002/0158421 A1
(43) Pub. Date: Oct. 31, 2002

(54) Shaft seal having a hinge and a liner

(76) Inventor: David Ernest Johnston, East Hebron, NH (US)

Correspondence Address: FREUDENBERG-NOK G.P., 47690 E. ANCHOR CT., PLYMOUTH, MI, 48170, US

(21) Appl. No.: 10/081,130

(22) Filed: Feb. 22, 2002

Related U.S. Application Data
(60) Provisional application No. 60/270,803, filed on Feb. 23, 2001.

(51) Int. Cl. F16J 15/32

(52) U.S. Cl. 277/549

(57) ABSTRACT

A seal assembly for use with a rotating element such as a shaft includes a case having an axial portion and a radial portion. A seal body is bonded to at least the radial portion of the case. A hinge is bonded to the seal body adjacent to a terminating section of the radial portion of the case. A lip is bonded to the hinge. A liner is attached to the lip. The majority of bending loads and stresses are incurred in the hinge, thus increasing the life of the liner.

### CROSS REFERENCE TO RELATED APPLICATION

This claims the benefit of U.S. provisional patent application identified as Application No. 60/270,803, filed Feb. 23, 2001.

### BACKGROUND OF THE INVENTION

This invention relates in general to seal assemblies for use in sealing a lubricant about a rotating element, such as a shaft. More specifically, this invention relates to a shaft seal of the type having a flexible lip that contacts the rotating shaft.

Flexible lips are bonded to housings and the like to form lip seals for sealing about rotating shafts. A lip of such a seal is subjected to bending loads and stresses, which reduces the life of the lip. Oftentimes, the lip is formed from an elastomeric element such as rubber. A lip seal retains lubricant on an oil side of the seal and prevents the entry of contaminants from an air side of the seal.

A wear surface can be formed from a reduced-friction material, such as polytetrafluoroethylene. For example, U.S. Pat. No. 6,168,164 B1 discloses a shaft seal having a seal element formed from a polymer material, such as polytetrafluoroethylene. Such construction results in bending loads and stresses on the polymer material, thus reducing its life.

### BREIF SUMMARY OF THE INVENTION

The present invention includes a shaft seal having a liner formed from a polymer material attached to an elastomeric hinge and lip portion of a seal body. The hinge and lip incur the majority of the bending loads and stresses, thus increasing the life of the liner. The liner provides a reduced-friction contact surface to the rotating element. The life and performance of the shaft seal assembly is improved.

In a preferred embodiment, a seal assembly for use with a rotating element such as a shaft includes a case having an axial portion and a radial portion. A seal body is bonded to at least the radial portion of the case. A hinge is bonded to the seal body adjacent to a terminating section of the radial portion of the case. A lip is bonded to the hinge. A liner is attached to the lip. The majority of bending loads and stresses are incurred in the hinge, thus increasing the life of the liner.

### BRIEF DESCRIPTION OF THE DRAWINGS

FIG. 1 is a sectional, partial view of a first preferred embodiment of a seal assembly according to this invention.

FIG. 2 is a sectional, partial view of a second preferred embodiment of a seal assembly according to this invention mounted on a rotating element.

FIG. 3 is an enlarged view of a portion of seal assembly of FIG. 2 contained in circle A, illustrating a lip portion and a liner.

### DETAILED DESCRIPTION OF THE PREFERRED EMBODIMENTS

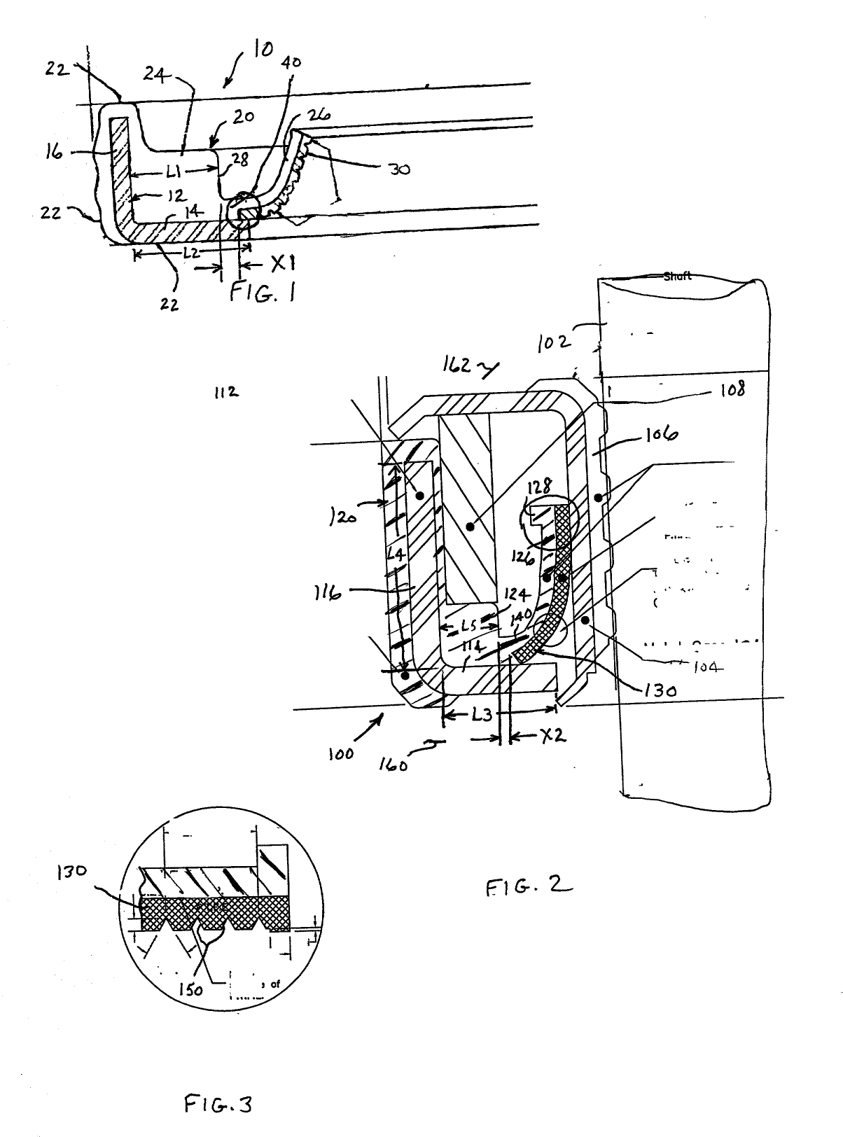

A first embodiment of a seal assembly is indicated generally at 10 in FIG. 1. The seal assembly 10 is illustrated prior to installation on a rotating element (not shown), such as a shaft. The seal assembly 10 includes a rigid case 12 and an elastomeric seal body 20 molded to the case 12. The seal assembly 10 is molded by compression, transfer, or injection molding process, or a combination of these processes, or similar processes. When the molding process is complete, flash 22 may be present at various outer surfaces of the seal assembly. Preferably, the flash 22 is removed prior to installation on a rotating member.

The case 12 is an annular member having a radial portion 14 and an axial portion 16. Preferably, the axial portion 16 is formed approximately perpendicular to the radial portion 14.

The seal body 20 includes a bonding or radial portion 24 and a flexible lip portion 26. The radial portion 24 is formed so that an inner radial boundary 28 is formed with a length L1 less than a length L2 of the radial portion 14 of the case 12. The lip portion 26 has a length that covers (extends over) and is in contact with at least a portion of the length L2 of the radial portion 14.

A liner 30 preferably formed from polytetrafluoroethylene is bonded to an inner surface of the lip portion 26. The liner 30 has a length that begins adjacent the radial portion 14 and extends preferably to a terminating point of the lip portion 26. However, a distance X1 is provided between an originating point of the liner 30 and the radial boundary 28.

When the lip portion 26 and liner 30 are flexed (as shown in FIG. 1) to accommodate a shaft or other rotating member (not illustrated), a hinge 40 is formed by the flexible lip portion 26. Thus, the lip portion 26 originates with the hinge 40. The hinge 40 receives or incurs the majority of bending loads and stresses as the lip portion 26 is flexed. Since the lip portion 26 is formed from a more durable material, such as a rubber, the lip portion 26 can withstand these loads. The liner 30 is attached to this hinge 40 and is subject to less stress than the hinge 40. Thus, the liner 30 has improved durability and longer life.

A second embodiment of a seal assembly 100 according to this invention is partially illustrated in FIGS. 2 and 3. The seal assembly 100 is shown mounted on a rotating shaft 102. The rotating shaft 102 includes a rigid case 104 and an elastomer 106 bonded to the case 104. A spacer 108, preferably formed from Nylon, is provided between the seal assembly 100 and the rotating shaft 102.

The seal assembly 100 is very similar to seal assembly 10. The seal assembly 100 includes a rigid case 112 having a radial portion 114 and an axial portion 116. In this embodiment, the length L3 of the radial portion 114 is less than a length L4 of the axial portion 116.

The seal assembly 100 also includes a seal body 120 having a bonding portion 124 and a flexible lip portion 126. The length L5 of the bonding portion 124 is less than the length L3 of the radial portion 114 so that the lip portion 126 is adjacent at least a portion of the radial portion 114.

A liner 130 is provided on an inner surface of the lip portion 126. Preferably, the liner 130 is formed from polytetrafluoroethylene. A distance X2 is provided between the start of the lip portion 126 and the start of the liner 130. In this manner, the liner 130 is subjected to less stress as a hinge 140 accommodates a majority of the bending stresses when the lip portion 126 and liner 130 are flexed to accommodate the rotating member 102.

The lip portion 126 can terminate in a raised portion 128, in the form of a ring, bead, or other desired shape. As illustrated in FIG. 3, grooves 150 can be provided in an inner surface of the liner 130. If desired, a light film of lubricant such as grease can be applied to a contacting surface of the liner 130.

A lubricant, such as oil, is retained in an oil side 160 of the seal assembly 100. Oil is prevented from leaking to an air side 162 of the seal assembly 100. The seal assembly 100 blocks contaminants from the air side 162.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A shaft seal assembly comprising:
a case;
an elastomeric seal body molded to the case;
a lip portion extending from the seal body, originating in a hinge portion; and
a liner attached to the lip portion.

2. The shaft seal assembly specified in claim 1 wherein:
the case includes a radial portion having a length;
the seal body includes a radial portion having a length less than the length of the radial portion of the case; and
the lip portion extends over at least a portion of the length of the radial portion of the case.

3. The shaft seal assembly specified in claim 2 wherein the lip portion is integrally formed with the seal body and extends over the length of the radial portion of the case of which the radial portion of the seal body does not extend.

4. The shaft seal assembly specified in claim 1 wherein the line is bonded to the lip portion.

5. The shaft seal assembly specified in claim 1 wherein the lip portion includes hydrodynamic grooves.

6. A seal assembly including:
a case having a radial portion;
a seal body molded to the case and not covering the entire radial portion of the case;
a lip portion extending from the seal body and covering the radial portion of the case not covered by the seal body; and
a liner attached to the lip portion.

7. The seal assembly specified in claim 6 wherein material of the lip portion adjacent the seal body and the radial portion of the case forms a flexible hinge.

8. The seal assembly specified in claim 7 wherein the liner is formed from polytetrafluoroethylene.

9. The seal assembly specified in claim 8 wherein the liner includes a contact surface.

10. The seal assembly specified in claim 9 wherein the contact surface includes at least one hydrodynamic groove.

11. The seal assembly for use with a rotating element, comprising:
a case having an axial portion and a radial portion;
a seal body bonded to at least the radial portion of the case;
a hinge bonded to the seal body adjacent to a terminating section of the radial portion of the case;
a lip bonded to the hinge; and
a liner attached to the lip.

12. The seal assembly specified in claim 11 wherein the seal body, the hinge, and the lip are integrally bonded together.

13. The seal assembly specified in claim 11 wherein the seal body, the hinge, and the lip are formed from an elastomeric material.

14. The seal assembly specified in claim 11 wherein the liner is formed from polytetrafluoroethylene.

15. The seal assembly specified in claim 11 wherein the liner includes at least one groove.

16. The seal assembly specified in claim 11 wherein the radial portion of the case has a length that is greater than a radial length of the seal body.

17. The seal assembly specified in claim 16 wherein the hinge extends over the radial portion of the case that is not covered by the seal body.

18. The seal assembly specified in claim 11 wherein the liner is bonded to the lip.

19. The seal assembly specified in claim 11 wherein the hinge receives more bending stresses than the liner.

20. The seal assembly specified in claim 11 wherein the lip receives more bending stresses than the liner.
